(19) United States
(12) Patent Application Publication
(10) Pub. No.: US 2012/0133110 A1
(43) Pub. Date: May 31, 2012

(54) Transportation Storage Device

(76) Inventor: Milton Savage, Corinth, TX (US)

(21) Appl. No.: 13/079,139

(22) Filed: Apr. 4, 2011

Related U.S. Application Data
(60) Provisional application No. 61/417,890, filed on Nov. 30, 2010.

(51) Int. Cl. B62B 3/02; F25D 3/00; B62B 5/04

(52) U.S. Cl. 280/638; 62/441

(57) ABSTRACT

A transportation storage device comprising a frame to provide a general shape for the transportation storage device, where the frame is wide enough to fit through a doorway; a plurality of adjustable height segments combined with a front height segment to create a peripheral support for the frame; a handle attached to a top portion of the frame to enable a user to control how the transportation storage device maneuvers; a pair of handle ends attached atop the plurality of adjustable height segments; a set of wheels attached to a bottom portion of the frame, where the set of wheels enables the user to push the transportation storage device; and a set of platforms attached between the plurality of adjustable height segments and the front height segment wherein the set of platforms provides a shelf for the user to place a plurality of items.

### CROSS REFERENCE TO OTHER APPLICATIONS

This application claims priority to U.S. Provisional Application Serial No. 61/417,890 filed on Nov. 30, 2010.

### BACKGROUND OF THE INVENTION

1. Field of the Invention

The present invention relates to a device to aid a user to transport their goods from one place to another utilizing a device that features enclosure, hanging and cooling functions.

2. Description of Related Art

Carrier buggies and carts are common items found at grocery stores, shopping centers, hospitals and office buildings. Many people use these carts to transport multiple items at one time without having to make multiple trips to carry the goods. The carts and buggies usually include wheels for transport and include supported walls to contain the items and therefore are convenient for the user.

A problem that many people face is the size and availability of the carts. Many times the carts are quite large and do not easily fit through conventional doorways or between narrow passages. Due to their size, most carts are awkward to maneuver and steer for the user. Additionally, the carts are not readily available to residential consumers who may like to transport groceries or shopping bags from their garage into their house or from their car into an apartment. Finally, none of the conventional buggies and carts includes any sort of cooling or refrigeration mechanism to keep their groceries cool during transport. The person must quickly carry their chilled items or provide a separate cooler in order to prevent melting or warming of the cooled goods.

It would be beneficial in the art to provide a transportation cart that is small enough to fit through small passages and easy for the user to maneuver. It would also be desirable in the art to provide a transportation cart that includes a cooling mechanism to enable the user to easily transport their frozen or chilled goods.

### SUMMARY OF THE INVENTION

In view of the foregoing disadvantages inherent in the prior art, the purpose of the present disclosure is to provide a device to aid a user to transport their goods from one place to another utilizing a device that features enclosure, hanging and cooling functions.

An object of the present invention is to provide a transportation device that enables a user to transport grocery items easily from one place to another.

Another object of the present invention is to provide a transportation device that includes a handle upon which a user may hang their bags or garments.

Another object of the present invention is to provide a cooling device within the transportation device wherein the user may store frozen or chilled items.

To achieve the above objects, in an aspect of the present invention, a transportation storage device is disclosed comprising a frame to provide a general shape for the transportation storage device, where the frame is wide enough to fit through a doorway; a plurality of adjustable height segments combined with a front height segment to create a peripheral support for the frame; a handle attached to a top portion of the frame to enable a user to control how the transportation storage device maneuvers; a pair of handle ends attached atop the plurality of adjustable height segments; a set of wheels attached to a bottom portion of the frame, where the set of wheels enables the user to push the transportation storage device; and a set of platforms attached between the plurality of adjustable height segments and the front height segment wherein the set of platforms provides a shelf for the user to place a plurality of items.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a transportation storage device according to an exemplary embodiment of the present invention; and

FIG. 2 depicts a perspective view of a transportation storage device according to an alternative embodiment of the present invention.

Like reference numerals refer to like parts throughout the description of several views of the drawings.

### DETAILED DESCRIPTION OF THE DRAWINGS

The present invention relates to a device to aid a user to transport their goods from one place to another utilizing a device that features enclosure, hanging and cooling functions. The present invention discloses a transportation storage device that provides individuals with a wheeled carrying device that features an internal cooling mechanism. The transportation storage device is a portable carrying apparatus that may be composed of multiple stacked units including carrying platforms, storage compartments and cooling mechanisms. The various components may be adjustable and interchangeable for ease and convenience, and may include an easy to use hand brake mechanism for additional handling and control. The transportation storage device may be especially useful at grocery stores and medical facilities when transporting goods and supplies, especially if those items need to remain cool or frozen.

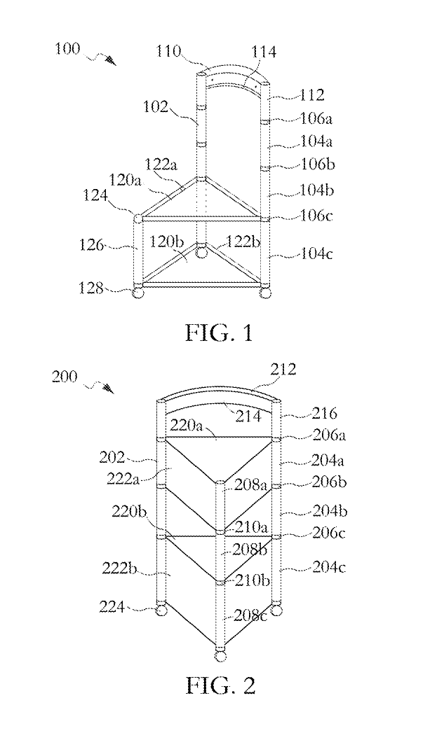

Turning now descriptively to the drawings, referring to FIG. 1, a perspective view of a transportation storage device (100) is shown in accordance with an exemplary embodiment of the present invention. The transportation storage device (100) may include a frame (102) or body which gives the transportation storage device (100) its general shape. The frame (102) may have a triangular prism shape (as shown), a cubed shape or even a cylindrical shape, all with a width small enough to easily fit through doorways or between narrow passageways. The frame (102) may include a plurality of adjustable height segments (104a, 104b, 104c) (hereinafter adjustable height segments) that extend from a lower portion of the frame (102) to a handle (110). The adjustable height segments (104a, 104b, 104c) may be made from a PVC tube which is lightweight and durable. The adjustable height segments (104a, 104b, 104c) may include a plurality of junctions (106a, 106b, 106c) attached between them to connect the individual adjustable height segments (104a, 104b, 104c) to each other.

At the top portion of the frame (102) is the handle (110). The handle (110) may include a pair of handle ends (112) to attach to the top most adjustable height segment (104a). The handle (110) may enable a user to steer and maneuver the transportation storage device (100). An alternate function of the handle (110) may be to provide a hanging bar where the user may hang one or more items. The handle (110) may be used as a location to hang dry cleaning, clothes and the like so that the items do not drag or get dirty when transporting multiple items.

Along the bottom portion of the handle (110) may be a brake grip (114). The brake grip (114) may enable the user to slow or stop the transportation storage device (100) when moving it from one location to another. The brake grip (114) is attached to a mechanism housed within the frame that controls a set of wheels (128) attached to the bottom portion of the transportation storage device (100). The amount of pressure used to squeeze the brake grip (114) controls how fast the set of wheels (128) will turn and eventually when they will stop.

Focusing on the lower portion of the frame (102) are a set of platforms (120a, 120b). The set of platforms (120a, 120b) are supported by a set of platform racks (122a, 122b). The set of platforms (120a, 120b) may rest on top of the set of platforms racks (122a, 122b) to create a platform or shelf where the user may place their goods or items. A front portion of the platform racks (122a, 122b) is supported by a front height segment (126) which is also attached to a front junction (124). The front height segment (126) paired with the lowest adjustable height segments (104c) create the peripheral supports for the platform racks (122a, 122b) so that they support the set of platforms (120a, 120b).

Along the bottom portions of the lowest adjustable height segments (104c) and the front height segment (126) are the set of wheels (128). The set of wheels (128) may screw into the frame (102) or alternatively they may snap into place. The set of wheels (128) enable the user to transport their items using only a single device from one place to another. The transportation storage device (100) allows the user to relocate their items with greater ease and convenience than having to carry the items or making multiple trips in order the carry everything. The set of platforms (120a, 120b) provide a place to set bags while the handle (110) provides a place to hang clothes. The user may take fewer trips from their vehicle into their home when transporting groceries, or simply find utility when moving items from one area of a building to another.

Referring now to FIG. 2, a perspective view of a transportation storage device (200) is shown in accordance with an alternative embodiment of the present invention. The alternative embodiment of the transportation storage device (200) may include similar features as the first embodiment of the transportation storage device (100), such as a frame (202), a plurality of adjustable height segments (204a, 204b, 204c), a plurality of junctions (206a, 206b, 206c), a handle (212), a brake grip (214) and a pair of handle ends (216). The transportation storage device (200) may include a plurality of front height segments (208a, 208b, 208c) attached to a front portion of the frame (202). The plurality of front height segments (208a, 208b, 208c) may be held together by a plurality of front junctions (210a, 210b) which may snap into place between the plurality of front segments (208a, 208b, 208c).

Additionally, within the frame (202) may be a plurality of storage compartments (220a, 220b). The plurality of storage compartments (220a, 220b) may include a plurality of walls (222a, 222b) that surround all sides. The plurality of storage compartments combined with the plurality of walls (222a, 222b) may provide an enclosed container for the user to place their items for transportation. The plurality of walls (222a, 222b) may be solid or non-permeable so that the plurality of storage compartments (220a, 220b) is waterproof. As such, the plurality of storage compartments (220a, 220b) may include a cooling device so ensure that any cold or frozen items placed inside remain cold during transport. The cooling device may be especially useful for those users who may walk from their home to the grocery store and need a device to get their groceries home. The transportation storage device (200) may provide not only a carrying device but also the necessary cooling device to keep the items cold for the entire walk home. Alternatively, the plurality of walls (222a, 222b) may be a mesh or basket like pattern wherein the plurality of storage compartments (220a, 220b) contain holes in the sides. These storage compartments (220a, 220b) may store items that do not require water proof sides or cooling.

The plurality of walls (222) may be added to the first embodiment of the transportation and storage device (100). The plurality of walls (222) may be added around the peripheral edges of the set of platforms (120a, 120b), under the set of platform racks (122a, 122b). With the plurality of side walls (222), the set of platforms (120a, 120b) may create enclosed containers to transport the user's items. Therefore, the first embodiment of the transportation storage device (100) may contain the user's items without them falling or spilling during movement.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A transportation storage device comprising:
a frame to provide a general shape for said transportation storage device, where said frame is small enough to fit through a doorway;
a plurality of adjustable height segments combined with a front height segment to create a peripheral support for said frame;
a handle attached to a top portion of said frame to enable a user to control how said transportation storage device maneuvers;
a pair of handle ends attached atop said plurality of adjustable height segments;
a set of wheels attached to a bottom portion of said frame, where said set of wheels enables said user to push said transportation storage device; and
a set of platforms attached between said plurality of adjustable height segments and said front height segment wherein said set of platforms provides a shelf for said user to place a plurality of items.

2. The transportation storage device according to claim 1, wherein said frame includes a plurality of walls to create a plurality of storage compartments therein providing an enclosed container for said user to place said plurality of items.

3. The transportation storage device according to claim 2, wherein said plurality of storage compartments includes a cooling device to enable said user to transport cold and frozen items.

4. The transportation storage device according to claim 2, wherein said plurality of walls are non-permeable so that said plurality of storage compartments are waterproof.

5. The transportation storage device according to claim 1, wherein said handle includes a brake grip to slow and stop said transportation storage device.

6. The transportation storage device according to claim 1, wherein handle provides a hanging bar to enable said user to hang said plurality of items from said handle.
